(19) United States
(12) Patent Application Publication
(10) Pub. No.: US 2017/0085503 A1
(43) Pub. Date: Mar. 23, 2017

(54) RECEPTION DEVICE, LINE NUMBER RECOGNITION CIRCUIT, LINE NUMBER RECOGNITION METHOD, AND PROGRAM

(71) Applicant: NEC Corporation, Tokyo (JP)

(72) Inventor: Hiroaki KATAOKA, Tokyo (JP)

(73) Assignee: NEC Corporation, Tokyo (JP)

(21) Appl. No.: 15/125,255

(22) PCT Filed: Mar. 4, 2016
(86) PCT No.: PCT/JP2015/056342

§ 371 Date: Sep. 12, 2016

(30) Foreign Application Priority Data
Mar. 17, 2014 (JP) 2014-053532

(51) Int. Cl. H04L 12/861; H04L 12/721

(52) U.S. Cl. CPC H04L 49/9057; H04L 45/44; H04L 49/9042

(57) ABSTRACT

A reception device that communicates with a transmission device which divides a frame into a plurality of divided frames and transmits the divided frames to be distributed through a plurality of lines. The device includes a reception unit that receives the divided frames; a restoration unit that restores the frame by combining the received divided frames; and a recognition unit that recognizes, according to control information included in the divided frames, the number of lines used by the transmission device which transmitted the divided frames.

### TECHNICAL FIELD

The present invention relates to a reception device, a line number recognition circuit, a line number recognition method, and a program.

### BACKGROUND ART

In a technical field related to the present invention, Layer 2 switches are used to relay communication between terminals which belong to different networks. In the connection between the Layer 2 switches, a technique called “traffic aggregation” to constitute a virtual communication line by bundling a plurality of communication lines have been implemented.

When the number of bundled communication lines is increased or decreased due to a change in the configuration or the like, the user must change the setting for switches connected to both ends of the communication lines. As a method to perform such setting change automatically, a process according to a protocol such as an LACP (Link Aggregation Control Protocol) is executed between the switches.

Patent Document 1 proposes a method to reduce power consumption by changing the number of the bundled communication lines in accordance with the traffic volume by using the LACP. Since the LACP performs a complex control, it is difficult to implement such control by using only a hardware resource such as an ASIC (Application Specific Integrated Circuit), a PLD (Programmable Logic Device), or an FPGA (Field Programmable Gate Array) or the like. Therefore, in order to implement required functions, the configuration of the relevant device becomes complex or delay time increases.

### PRIOR ART DOCUMENT

### Patent Document

Patent Document 1: Japanese Unexamined Patent Application, First Publication No. 2011-44842.

### DISCLOSURE OF INVENTION

### Problem to be Solved by the Invention

However, when the LACP is not used, the switch on the receiving side cannot recognize an increase or decrease in the number of the communication lines at the switch on the transmission side until the relevant setting is made for the own device (switch on the receiving side). Therefore, when the number of the communication lines increases, the receiving-side switch cannot recognize frames transmitted via each added communication line and thus a frame reception waiting state always occurs. In addition, when the number of the communication lines decreases, the receiving-side switch waits for even a frame transmitted through each communication line that is no longer used.

An object of the present invention is to provide a reception device, a line number recognition circuit, a line number recognition method, and a program, which can solve the above problems.

### Means for Solving the Problem

In order to solve the above problem, the present invention provides a reception device that communicates with a transmission device which divides a frame into a plurality of divided frames and transmits the divided frames to be distributed through a plurality of lines, the device comprising:

a reception unit that receives the divided frames;

a restoration unit that restores the frame by combining the received divided frames; and

a recognition unit that recognizes, according to control information included in the divided frames, the number of lines used by the transmission device which transmitted the divided frames.

In a preferable example, the device further comprises:

a first buffer unit that includes one or more buffers having a first attribute and storing the received divided frames;

a second buffer unit that includes one or more buffers having a second attribute and storing the received divided frames; and

a control unit that:
determines, according to the control information included in the divided frames stored in the first buffer unit, validity of the order in which the divided frames were received, and
acquires each divided frame, which was received in a correct order, from the first buffer unit;

wherein when the control unit detects a divided frame which was received in an incorrect order, the recognition unit controls the control unit to continuously store each received divided frame stored in the buffer unit that stores the relevant frame until the total number of the divided frames stored in the first and second buffer units coincides with the number of lines.

In this case, when the total number coincides with the number of lines after the control unit detects the divided frame which was received in the incorrect order, the recognition unit may change the attribute of the second buffer unit, which stores the divided frames, to the first attribute and change to attribute of the first buffer unit, which stores no divided frame, to the second attribute.

Furthermore, the device further comprises:

a learning unit that learns an identification information item of a communication interface through which each divided frame was received;

wherein the recognition unit determines the number of the identification information items learned by the learning unit to be the total number.

The present invention also provides a line number recognition circuit provided in a reception device that communicates with a transmission device, which divides a frame into a plurality of divided frames and transmits the divided frames to be distributed through a plurality of lines, so as to receive the divided frames, where the reception device restores the frame by combining the received divided frames and the circuit comprises:

a recognition unit that recognizes, according to control information included in the divided frames, the number of lines used by the transmission device which transmitted the divided frames.

The present invention also provides a line number recognition method performed by a reception device that communicates with a transmission device, which divides a frame into a plurality of divided frames and transmits the divided frames to be distributed through a plurality of lines, so as to receive the divided frames, where the reception device restores the frame by combining the received divided frames and the method comprises:

a recognition step that recognizes, according to control information included in the divided frames, the number of lines used by the transmission device which transmitted the divided frames.

The present invention also provides a program that makes a computer function as a reception device that communicates with a transmission device, which divides a frame into a plurality of divided frames and transmits the divided frames to be distributed through a plurality of lines, so as to receive the divided frames, where the reception device restores the frame by combining the received divided frames and the program comprises:

a recognition step that recognizes, according to control information included in the divided frames, the number of lines used by the transmission device which transmitted the divided frames.

### Effect of the Invention

In accordance with the present invention, in a transmission device and a reception device which communicate with each other by the traffic aggregation, it is possible to reduce the waiting time for the frame reception at the reception device, which is caused by an increase or decrease in the number of communication lines at the transmission device.

### BRIEF DESCRIPTION OF THE DRAWINGS

FIG. 1 is a system configuration diagram showing a system configuration of a communication system 1 according to an embodiment.

FIG. 2 is a functional block diagram showing the functional configuration of a transmission device 4.

FIG. 3 is a diagram showing a specific example of a frame generated by dividing a user frame.

FIG. 4 is a diagram showing a specific example of control information 63 of a frame 6.

FIG. 5 is a functional block diagram showing a functional configuration of a reception device 5.

FIG. 6 is a diagram showing a specific example of a destination information table 541.

FIG. 7 is a functional block diagram showing details of the functions of a communication control unit 56.

FIG. 8 is a flowchart showing the operation flow of a communication control unit 56 in the embodiment.

FIG. 9 is a functional block diagram showing a functional configuration of a line number recognition circuit 56a as the minimum configuration of the present invention.

### MODE FOR CARRYING OUT THE INVENTION

Although an embodiment of the present invention will be explained below, it does not limit the invention according to the claims. In addition, all combinations of features that are described in the embodiments are not always essential to solve the above problems.

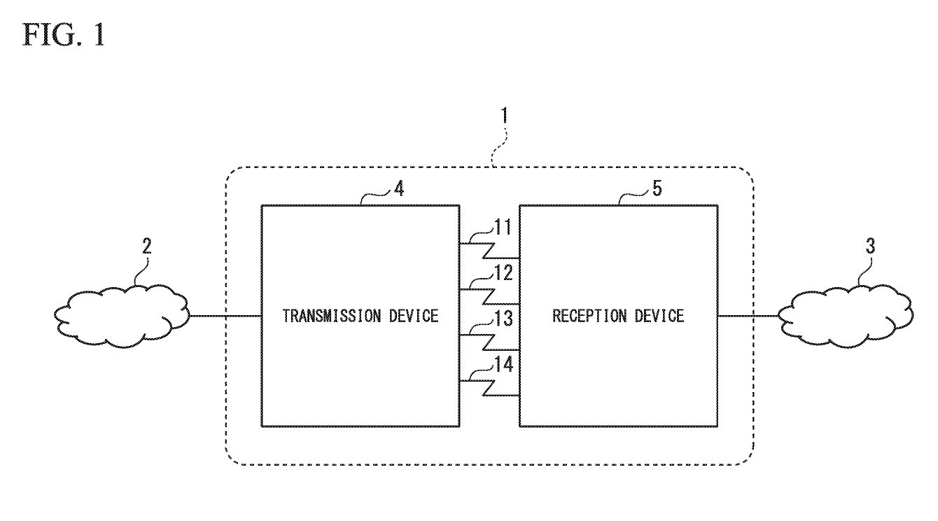

FIG. 1 is a system configuration diagram showing a system configuration of a communication system 1 of the embodiment.

The communication system 1 is a system utilized to relay communication between a network 2 and a network 3.

The communication system 1 includes communication lines 11 to 14, a transmission device 4, and a reception device 5.

The communication lines 11 to 14 are communication lines utilized to connect the transmission device 4 and the reception device 5 with each other. FIG. 1 shows the four communication lines 11-14. In accordance with the number of communication interfaces of the transmission device 4 and the reception device 5, a different number of communication lines in comparison with FIG. 1 may be provided. Hereinafter the communication lines between the transmission device 4 and the reception device 5 will be generally called “lines”.

The transmission device 4 receives each frame transmitted from a terminal, which belongs to the network 2, to a terminal which belongs to the network 3.

Here, “frame” is a unit of data communicated between communication devices. The frame is generated by adding information such as transmission source information, destination information, and the like, to user data. The transmission source information is identification information for a terminal that transmitted the frame. The destination information is identification information for a terminal as the destination of the transmitted frame.

In the communication at Layer 2, a communication interface of MAC (Media Access Control) address is used for the transmission source information and the destination information. The data format of the frame is defined in accordance with an employed communication standard.

For example, the data format of an Ethernet (registered trademark) frame is defined by a communication standard of the Ethernet (registered trademark). In the following explanation, a frame transmitted from a terminal is called a “user frame”.

The transmission device 4 divides a received user frame into user frames as new user data. The transmission device 4 adds information such as the transmission source information and the destination information to each divided user frame to generate new frames. The transmission source information added here is information about the own transmission device. The destination information is information about the reception device 5.

The transmission device 4 transmits the generated frames to the reception device 5 through the communication lines 11 to 14.

The reception device 5 receives the frames transmitted from the transmission device 4. The reception device 5 combines the received frames to restore the original user frame which was divided by the transmission device 4.

The reception device 5 transmits the restored user frame to a terminal belonging to the network 3, which is indicated by the destination information of the relevant user frame.

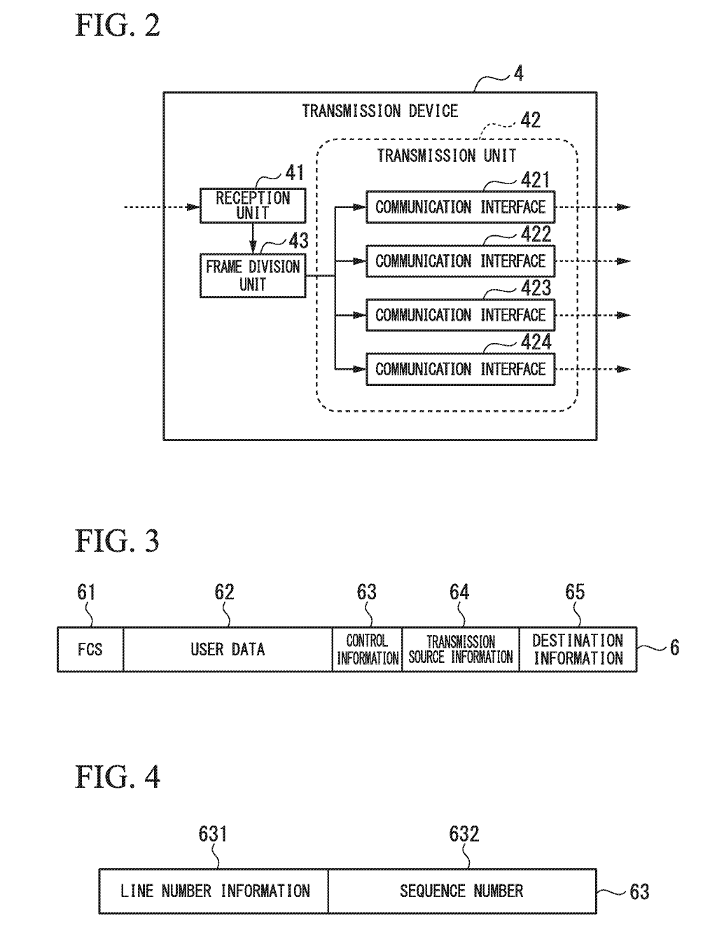

FIG. 2 is a functional block diagram showing the functional configuration of the transmission device 4.

The transmission device 4 has a CPU, a memory, an auxiliary storage device, and the like, which are connected via buses, and runs a transmission program. The transmission device 4 functions as a device that includes a reception unit 41, a transmission unit 42, and a frame division unit 43 by running the transmission control program.

All or part of the functions of the transmission device 4 may be implemented utilizing a hardware resources such as the ASIC (Application Specific Integrated Circuit), the PLD (Programmable Logic Device), or the FPGA (Field Programmable Gate Array).

Additionally, the transmission control program may be stored in a computer-readable storage medium. The computer-readable storage medium may be a portable medium such as a flexible disk, a magneto optical disk, a ROM, or a CD-ROM, or a storage device such as a hard disk built in a computer system. The transmission control program may be communicated via an electric communication line.

The reception unit 41 is configured using a communication interface such as LAN (Local Area Network). The reception unit 41 receives each user frame transmitted from the terminal which belongs to the network 2.

The transmission unit 42 is configured using a communication interface such as the LAN. In the example of FIG. 2, the transmission unit 42 is provided with four communication interfaces 421 to 424. Here, the number of communication interfaces provided in the transmission unit 42 may be different from that shown in FIG. 2.

The transmission unit 42 transmits the frame output from the frame division unit 43 to the reception device 5.

The frame division unit 43 divides the user frame received by the reception unit 41. Although the user frame may be divided into frames having any size, it is desirable to be divided into frames having a predetermined size in order to equalize the traffic between the communication lines 11 to 14.

The frame division unit 43 adds information such as the transmission source information and the destination information to each divided user frame as new user data so as to generate new frames. In addition, the frame division unit 43 adds control information to each generated frame. Details of the control information will be described later.

The frame division unit 43 outputs the generated frames to be distributed into the communication interfaces included in the transmission unit 42.

FIG. 3 is a diagram showing a specific example of a frame generated by dividing the user frame.

A frame 6 is a new frame generated by the frame division unit 43 which divides a user frame received by the transmission device 4, where the new frame is to be transmitted to the reception device 5.

The frame 6 includes an FCS 61 (Frame Check Sequence), user data 62, control information 63, transmission source information 64, and destination information 65.

The FCS61 is information added to check, by a device which receives the frame 6, whether there is no error in the data contained in the frame 6.

The user data 62 is divided user data generated by dividing the user frame by the frame division unit 43.

Details of the control information 63 will be described later with reference to FIG. 4.

The transmission source information 64 is information about the transmission source of the frame 6 and specifically is the MAC address of a communication interface included in the transmission unit 42 of the transmission device 4.

The destination information 65 is information about the destination of the frame 6 and specifically is the MAC address of a communication interface included in a reception unit 51 of the reception device 5.

FIG. 4 is a diagram showing a specific example of the control information 63 of the frame 6.

The control information 63 includes line number information 631 and a sequence number 632.

The line number information 631 is information which indicates the number of lines used by the transmission device 4. In accordance with the line number information 631 included in the control information 63 of the received frame 6, the reception device 5 recognizes the number of lines used by the transmission device 4.

The sequence number 632 is information which indicates the order in which each frame 6 is transmitted from the transmission device 4. The frames 6 generated from the same user frame are transmitted in the order in which they are combined by the reception device 5. Therefore, the reception device 5 combines the user data 62 according to the order indicated by the sequence numbers 632 of the received frames 6, so as to restore the original user frame.

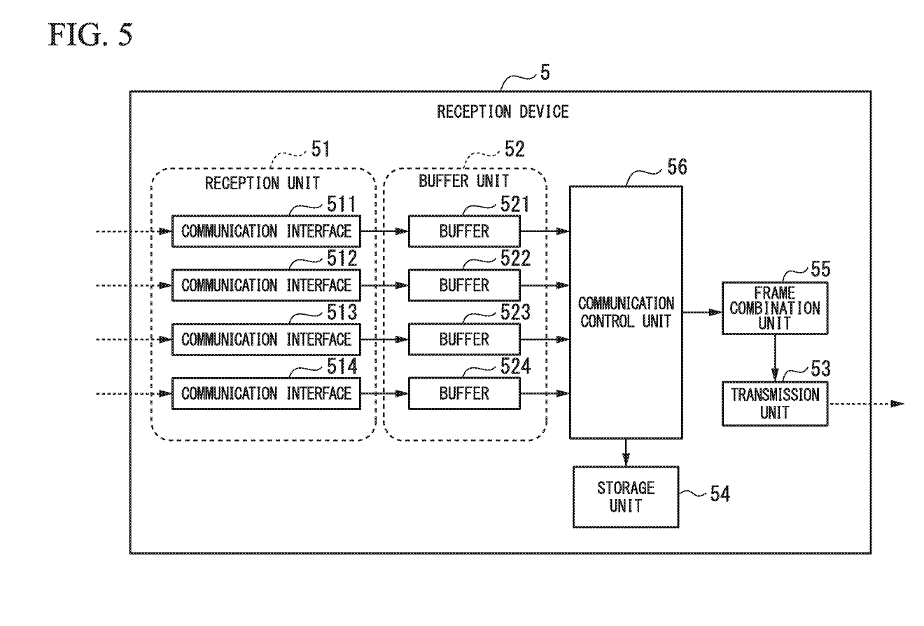

FIG. 5 is a functional block diagram showing a functional configuration of the reception device 5.

The reception device 5 has a CPU, a memory, an auxiliary storage device, and the like, which are connected via buses and runs a reception control program. The reception device 5 functions as a device that includes a reception unit 51, a buffer unit 52, a transmission unit 53, a storage unit 54, a frame combination unit 55, and a communication control unit 56 by running the reception control program.

All or part of the functions of the reception device 5 may be implemented utilizing a hardware resource such as the ASIC, the PLD, or the FPGA. Additionally, the transmission program may be stored in a computer-readable storage medium.

The computer-readable storage medium may be a portable medium such as a flexible disk, a magneto optical disk, a ROM, or a CD-ROM, or a storage device such as a hard disk built in a computer system. The transmission control program may be communicated via an electric communication line.

The reception unit 51 is configured using a communication interface such as the LAN. In the example of FIG. 5, the reception unit 51 is provided with four communication interfaces 511 to 514. Here, the number of communication interfaces provided in the reception unit 51 may be different from that shown in FIG. 5.

The reception unit 51 receives each frame 6 transmitted from the transmission device 4. The reception unit 51 stores the received frame 6 in one of buffers included in the buffer unit 52, which corresponds to the communication interface through which the frame 6 is received.

The buffer unit 52 is formed using a storage device such as a semiconductor storage device. The buffer unit 52 has a buffer corresponding to each communication interface included in the reception unit 51. For example, in FIG. 5, the buffer unit 52 has buffers 521 to 524 which respectively correspond to the communication interfaces 511 to 514.

Each buffer stores the frame 6 received by the corresponding communication interface.

Each of the buffers in the buffer unit 52 is used as an active buffer or an auxiliary buffer by the reception device 5.

The active buffer is a buffer as a target for which a reception process is executed. In the reception process, the reception device 5 acquires the received frames 6 from the active buffers and combines them to restore the original user frame.

Among the buffers included in the buffer unit, each buffer other than the active buffers is the auxiliary buffer. That is, lines utilized by the communication interfaces corresponding to the active buffers are lines utilized by the reception device 5.

Typically, the transmission device 4 transmits each frame 6 to a communication interface (as the destination) corresponding to an active buffer. Then, the reception device 5 performs the reception process on the frame 6 stored in each active buffer to restore the original user frame.

Here, it is assumed that the reception process is performed for all buffers (i.e., the active and auxiliary buffers) provided in the reception device 5. In this case, if reception of any frame 6 is delayed for a certain reason, the reception device 5 waits for the relevant frame 6 with all buffers as targets. However, if there is no change in the lines used by the transmission device 4, the possibility that the relevant frame 6 is received by an auxiliary buffer is low. Therefore, when the reception process is performed on all the buffers provided in the reception device 5, the delay time for the communication may increase. Therefore, the reception device 5 performs the reception process for the active buffers.

However, when the number of lines used by the transmission device 4 is increased, the transmission device 4 starts to transmit the frame 6 to the communication interface (as the destination) corresponding to the auxiliary buffer of the reception device 5. Accordingly, the reception device 5 does not perform the reception process for the frame 6 stored in the auxiliary buffer until the reception device 5 recognizes that the number of lines was increased in the transmission device 4. As a result, the reception device 5 continuously waits for the frame 6, which has been stored in the auxiliary buffer, to be received in the active buffer.

For the above reason, in order to communicate each frame 6 normally between the transmission device 4 and the reception device 5, it is necessary that the lines used by the transmission device 4 coincide with the lines used by the reception device 5.

The transmission unit 53 is configured using a communication interface such as the LAN. The transmission unit 53 transmits the user frame restored by the frame combination unit 55 to a terminal (as the destination) belonging to the network 3, according to the destination information included in the user frame.

The storage unit 54 is configured using a storage device such as a magnetic hard disk device or a semiconductor storage device. The storage unit 54 stores a destination information table 541 in advance.

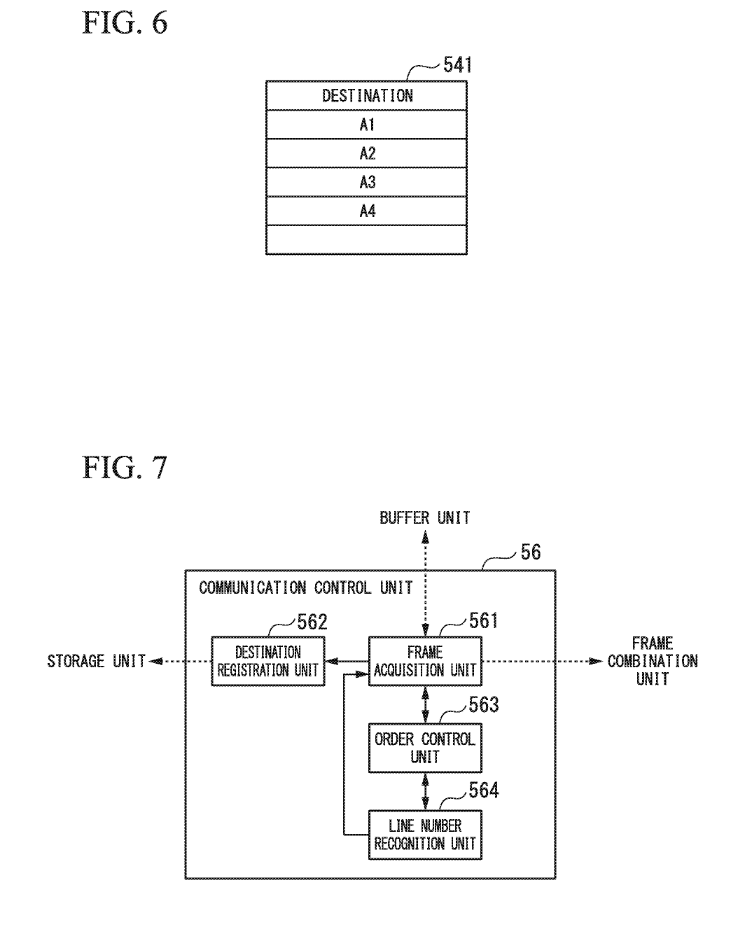

FIG. 6 is a diagram showing a specific example of the destination information table 541.

The destination information table 541 is a table utilized to store the destination information 65 of each frame 6 received by the reception device 5. The destination information table 541 has a destination information record for each destination information item. The destination information record has a value of destination which is destination information indicated by the destination information 65 of the frame 6.

In the example of FIG. 6, items of the destination information 65 corresponding to the communication interfaces included in the reception unit 51 are “A1”, “A2”, “A3”, and “A4”. The destination information table 541 is dynamically updated by the communication control unit 56.

Returning to FIG. 5, the frame combination unit 55 combines the frames according to the sequence number 632 included in the control information 63 of each frame 6, so as to restore the user frame. The frame combination unit 55 outputs the restored user frame to the transmission unit 53.

According to the control information 63 included in each received frame 6, the communication control unit 56 confirms the validity of the order in which the frames have been received.

Additionally, according to the line number information 631 included in the control information 63, the communication control unit 56 recognizes an increase or decrease in the number of lines in the transmission device 4.

Furthermore, according to the line number information 631 and the destination information table 541, the communication control unit 56 determines whether a line has been added or removed and which communication interface corresponds to the line.

FIG. 7 is a functional block diagram showing details of the functions of the communication control unit 56.

The communication control unit 56 includes a frame acquisition unit 561, a destination registration unit 562, an order control unit 563, and a line number recognition unit 564.

The frame acquisition unit 561 reads or acquires the frame 6 stored in each buffer.

The reading of the frame 6 is to perform only the readout of the data of the frame 6 stored in the buffer. In the reading of the frame 6, the frame 6 is not deleted from the buffer and is stored continuously.

In contrast, in the acquisition of the frame 6, the data of the frame 6 is read out and the frame is deleted from the buffer.

The frame acquisition unit 561 is able to perform the reading and the acquisition of the frame 6 for all buffers (i.e., active and auxiliary buffers).

The frame acquisition unit 561 operates by an instruction from the destination registration unit 562, the order control unit 563, and the line number recognition unit 564. Therefore, the following explanation represents that the reading and the acquisition of the frame 6 are performed by the destination registration unit 562, the order control unit 563, and the line number recognition unit 564.

The destination registration unit 562 registers the destination information 65 of the frames 6 received in all buffers (active and auxiliary buffers) with the destination information table 541.

The destination registration unit 562 also sets a timer for each destination information record and deletes each destination information record for which a predetermined time has elapsed. If the destination information record having the destination information 65 of the received frame has already been registered, the destination registration unit 562 resets the timer for that destination information record. Accordingly, the destination information 65 corresponding to a communication interface which has received no frame 6 for the predetermined time is deleted.

According to the sequence number 632 included in each received frame 6, the order control unit 563 confirms the validity of the order in which the frames 6 have been received. According to the result of the confirmation of the validity, the order control unit 563 outputs the received frame 6 to the frame combination unit 55.

According to the line number information 631 included in each received frame 6, the line number recognition unit 564 recognizes an increase or decrease in the number of lines in the transmission device 4. When such an increase or decrease is recognized, the line number recognition unit 564 stores the received frames in the buffers until the number of the destination information records registered with the destination information table 541 coincides with the relevant number of lines. According to the storage of the frames 6, the line number recognition unit 564 recognizes which line has been added or removed.

The line number recognition unit 564 changes the auxiliary buffer corresponding to an added line to the active buffer. Additionally, the line number recognition unit 564 changes the active buffer corresponding to a removed line to the auxiliary buffer.

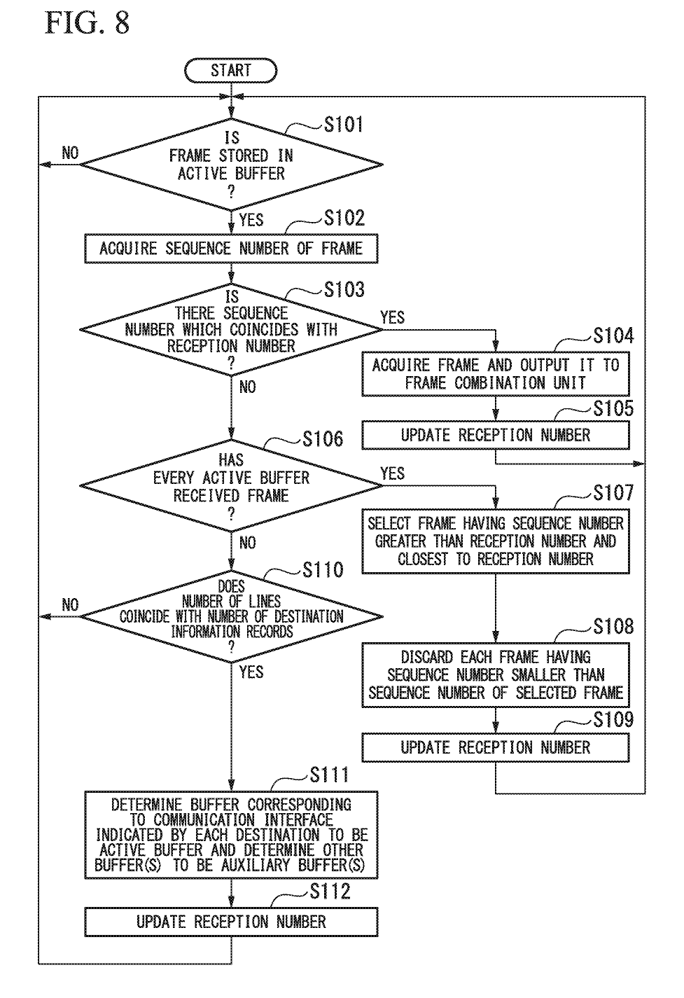

FIG. 8 is a flowchart showing the operation flow of the communication control unit 56 in the present embodiment.

First, the order control unit 563 determines whether or not a frame is stored in any active buffer (see step S101).

If no frame is stored in the active buffer (i.e., “NO” in step S101), the process in step S101 is repeated until a frame is received in an active buffer.

In contrast, if a frame is stored in any active buffer (i.e., “YES” in step S101), the order control unit 563 reads out the control information (63) from each frame stored in the active buffer.

The order control unit 563 acquires the sequence number (632) from the read control information (see step S102).

The order control unit 563 determines whether or not there is a sequence number among the obtained sequence numbers that coincides with the sequence number (called a “reception number” below) which should be received (see step S103). Specifically, the reception number is a sequence number to be received next to the sequence number of the frame received immediately before.

If there is a sequence number that coincides with the reception number (i.e., “YES” in step S103), the order control unit 563 acquires the frame having the relevant sequence number from the corresponding buffer and outputs it to the frame combination unit 55 (see step S104).

The order control unit 563 updates the reception number from the current reception number to the next reception number (see step S105). Then the operation starting from step S101 is repeated.

In contrast, if there is no sequence number that coincides with the reception number (i.e., “NO” in step S103), the line number recognition unit 564 determines whether or not every active buffer stores a frame (see step S106).

If every active buffer stores a frame (i.e., “YES” in step S106), the line number recognition unit 564 selects a frame having a sequence number that is greater than the relevant reception number and closest to this reception number (see step S107).

The line number recognition unit 564 then discards each frame having a sequence number smaller than the sequence number of the selected frame (see step S108). According to the discard of the frame, the reception device 5 can continue the reception of the frame.

The line number recognition unit 564 updates the reception number to the sequence number of the selected frame as the next reception number (see step S109).

Then the operation returns to step S101 and the above processes are repeated.

In contrast, in step S106, if part of the active buffers stores no frame (i.e., “NO” in step S106), the line number recognition unit 564 selects a frame having the greatest sequence number from among the frames stored in the active buffers. The line number recognition unit 564 acquires the line number information (631) from the selected frame.

The line number recognition unit 564 then determines whether or not the number of lines indicated by the acquired line number information coincides with the number of the destination information records registered with the destination information table 541 (see step S110).

If the number of lines does not coincide with the number of the destination information records (i.e., “NO” in step S110), the operation returns to step S101 so that the frame reception is continued.

In contrast, in step S110, if the number of lines coincides with the number of the destination information records (i.e., “YES” in step S110), the line number recognition unit 564 determines the buffer corresponding to the communication interface indicated by the value of the destination in each destination information record to be the active buffer and determines the other buffer(s) to be the auxiliary buffer(s) (see step S111).

Specifically, if the buffers, each corresponding to the communication interface indicated by the value of the destination in each destination information record, include a buffer (i.e., auxiliary buffer) other than the active buffer, the relevant buffer is changed to the active buffer. Accordingly, the line number recognition unit 564 recognizes that the line utilized by the communication interface corresponding to the relevant buffer is an added line.

In addition, if there is an active buffer that is not included in the buffers, each corresponding to the communication interface indicated by the value of the destination in each destination information record, the active buffer is changed to an auxiliary buffer. Accordingly, the line number recognition unit 564 recognizes that the line utilized by the communication interface corresponding to the relevant active buffer is a removed line.

Then, the line number recognition unit 564 updates the reception number to the smallest number among the sequence numbers of the frames stored in the active buffers, (see step S112). Then the operation returns to step S101 and the above processes are repeated.

In the communication system 1 as configured above, the reception device 5 recognizes an increase or decrease in the number of lines at the transmission device 4, according to the line number information included in the control information of received frames. The reception device 5 also recognizes an added or removed line by continuously storing the received frames in the buffers until the number of the destination information items of the received frames coincides with the number of lines indicated by the line number information.

In accordance with the recognized increase or decrease in the number of lines, the reception device 5 performs a change from the active buffer to the auxiliary buffer, or from the auxiliary buffer to the active buffer.

According to the above control, the communication system 1 can quickly recognize an increase or decrease in the number of lines performed at the transmission device 4. Therefore, it is possible to reduce the delay time due to the frame reception waiting caused by the increase or decrease in the number of lines at the transmission device 4.

In addition, since the reception device 5 of the above embodiment can recognize the increase or decrease in the number of lines at the transmission device 4 according to the control information included in each frame transmitted from the transmission device 4, no complicated control using the LACP is necessary. Therefore, the possibility that the communication control unit 56 of the reception device 5 can be implemented using a hardware resource such as the ASIC, the PLD, or the FPGA is high.

When the function of the communication control unit 56 is implemented by such a hardware resource, the communication system 1 can effectively use the communication band and perform the communication with small delay.

### Variation

The transmission device 4 and the reception device 5 may be configured as communication devices, each having both functions of these devices, so as to relay bidirectional communication between the network 2 and the network 3.

Additionally, one-to-one correspondence between the transmission device 4 and the reception device 5 is not always necessary. For example, the transmission device 4 in FIG. 2 may communicate with the reception device 5 by using the communication interfaces 421 and 422 and communicate with another reception device by using the communication interfaces 423 and 424.

Below, a minimum configuration of the present invention will be explained.

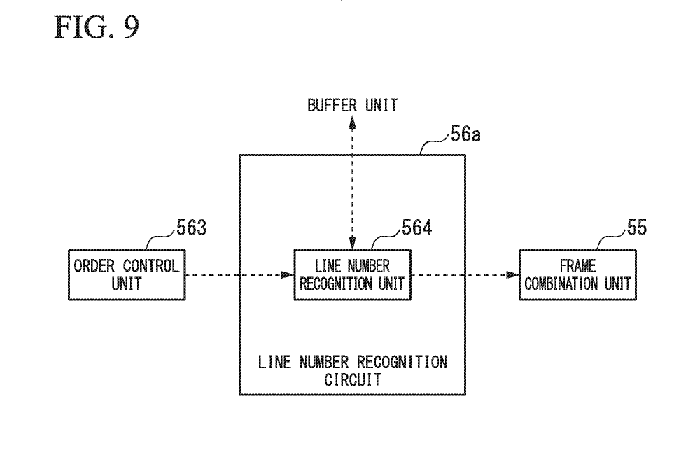

FIG. 9 is a functional block diagram showing a functional configuration of a line number recognition circuit 56a as the minimum configuration.

In FIG. 9, functional units having functions similar to those of the communication control unit 56 shown in FIG. 7 are given identical reference numerals of the corresponding units in FIG. 7. The line number recognition circuit 56a has a line number recognition unit 564

When a reception device, which has a reception unit 51, a buffer unit 52, a transmission unit 53, an order control unit 563 (provided separately from the line number recognition circuit 56a in the present configuration), and a frame combination unit 55, is provided with the line number recognition circuit 56a, the reception device is able to recognize an increase or decrease in the number of lines in the transmission device 4 according to the line number information 631 of each received frame 6 and also able to recognize the number of lines after the increase or decrease.

While embodiments of the present invention have been explained in detail with reference to the drawings, specific structures are not limited to the embodiments. Design modifications or the like can be made without departing from the scope of the present invention.

Priority is claimed on Japanese Patent Application No. 2014-053532, filed Mar. 17, 2014, the contents of which are incorporated herein by reference.

### INDUSTRIAL APPLICABILITY

In accordance with the present invention, in a transmission device and a reception device which communicate with each other by the traffic aggregation, it is possible to reduce the waiting time for the frame reception at the reception device, which is caused by an increase or decrease in the number of communication lines at the transmission device.

### REFERENCE SYMBOLS

1 communication system
11, 12, 13, 14 communication line
2, 3 network
4 transmission device
41 reception unit
42 transmission unit
421-424 communication interface
43 frame division unit
5 reception device
51 reception unit
511-514 communication interface
52 buffer unit
521-524 buffer
53 transmission unit
54 storage unit
541 destination information table
55 frame combination unit
56 communication control unit
561 frame acquisition unit
562 destination registration unit
563 order control unit
564 line number recognition unit
6 frame
61 FCS (Frame Check Sequence)
62 user data
63 control information
631 line number information
632 sequence number
64 transmission source information
65 destination information

1. A reception device that communicates with a transmission device which divides a frame into a plurality of divided frames and transmits the divided frames to be distributed through a plurality of lines, the device comprising:
a reception unit that receives the divided frames;
a restoration unit that restores the frame by combining the received divided frames; and
a recognition unit that recognizes, according to control information included in the divided frames, the number of lines used by the transmission device which transmitted the divided frames.

2. The reception device in accordance with claim 1, further comprising:
a first buffer unit that includes one or more buffers having a first attribute and storing the received divided frames;
a second buffer unit that includes one or more buffers having a second attribute and storing the received divided frames; and
a control unit that:
determines, according to the control information included in the divided frames stored in the first buffer unit, validity of the order in which the divided frames were received, and
acquires each divided frame, which was received in a correct order, from the first buffer unit;
wherein when the control unit detects a divided frame which was received in an incorrect order, the recognition unit controls the control unit to continuously store each received divided frame stored in the buffer unit that stores the relevant frame until the total number of the divided frames stored in the first and second buffer units coincides with the number of lines.

3. The reception device in accordance with claim 2, wherein when the total number coincides with the number of lines after the control unit detects the divided frame which was received in the incorrect order, the recognition unit changes the attribute of the second buffer unit, which stores the divided frames, to the first attribute and changes the attribute of the first buffer unit, which stores no divided frame, to the second attribute.

4. The reception device in accordance with claim 3, further comprising:
a learning unit that learns an identification information item of a communication interface through which each divided frame was received;
wherein the recognition unit determines the number of the identification information items learned by the learning unit to be the total number.

5. A line number recognition circuit provided in a reception device that communicates with a transmission device, which divides a frame into a plurality of divided frames and transmits the divided frames to be distributed through a plurality of lines, so as to receive the divided frames, where the reception device restores the frame by combining the received divided frames and the circuit comprises:
a recognition unit that recognizes, according to control information included in the divided frames, the number of lines used by the transmission device which transmitted the divided frames.

6. A line number recognition method performed by a reception device that communicates with a transmission device, which divides a frame into a plurality of divided frames and transmits the divided frames to be distributed through a plurality of lines, so as to receive the divided frames, where the reception device restores the frame by combining the received divided frames and the method comprises:
a recognition step that recognizes, according to control information included in the divided frames, the number of lines used by the transmission device which transmitted the divided frames.

7. A non-transitory computer-readable storage medium that stores a program that makes a computer function as a reception device that communicates with a transmission device, which divides a frame into a plurality of divided frames and transmits the divided frames to be distributed through a plurality of lines, so as to receive the divided frames, where the reception device restores the frame by combining the received divided frames and the program comprises:
a recognition step that recognizes, according to control information included in the divided frames, the number of lines used by the transmission device which transmitted the divided frames.
